(19) United States
(12) Patent Application Publication
(10) Pub. No.: US 2025/0142451 A1
(43) Pub. Date: May 1, 2025

(54) UE DISCOVERY FOR UE COOPERATION

(71) Applicant: QUALCOMM Incorporated, San Diego, CA (US)

(72) Inventors: Luanxia YANG, Beijing (CN); Aleksandar DAMNJANOVIC, Del Mar, CA (US); Fang YUAN, Beijing (CN); Xiaoxia ZHANG, San Diego, CA (US); Tao LUO, San Diego, CA (US); Jing SUN, San Diego, CA (US); Jelena DAMNJANOVIC, Del Mar, CA (US); Changlong XU, Beijing (CN); Rajat PRAKASH, San Diego, CA (US)

(21) Appl. No.: 18/833,740

(22) PCT Filed: Apr. 1, 2022
(86) PCT No.: PCT/CN2022/084743

§ 371 Date: Jul. 26, 2024

(51) Int. Cl. H04W 48/08

(52) U.S. Cl. CPC H04W 48/08

(57) ABSTRACT

Certain aspects of the present disclosure provide techniques for user equipment (UE) cooperation. Certain aspects provide a method for wireless communication by a target UE. The method generally includes receiving availability information indicating availability of one or more candidate UEs for cooperating with the target UE for communicating with a network entity, receiving assistance information from at least one of the candidate UEs, establishing a cooperation connection with the at least one of the candidate UEs based on the assistance information, and transmitting, to the network entity, an indication of UE capability based on the cooperation connection.

### INTRODUCTION

Aspects of the present disclosure relate to wireless communications, and more particularly, to techniques for user equipment (UE) cooperation.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a target user equipment (UE). The method generally includes receiving availability information indicating availability of one or more candidate UEs for cooperating with the target UE for communicating with a network entity, receiving assistance information from at least one of the candidate UEs, establishing a cooperation connection with the at least one of the candidate UEs based on the assistance information, and transmitting, to the network entity, an indication of UE capability based on the cooperation connection.

One aspect provides another method for wireless communication by a candidate user equipment (UE). The method generally includes transmitting, to a target UE, availability information indicating availability of the candidate UE for cooperating with the target UE for communicating with a network entity, transmitting, to the target UE, assistance information, and establishing a cooperation connection with the target UE based on the assistance information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station (BS) and a user equipment (UE).

FIGS. 3A, 3B, 3C, and 3D depict various example aspects of data structures for a wireless communication network.

FIG. 4A illustrates wireless communications without UE cooperation, in accordance with certain aspects of the present disclosure.

FIG. 4B illustrates wireless communications 400B with UE cooperation, in accordance with certain aspects of the present disclosure.

FIG. 5 illustrates example signaling 500 for indicating UE capability updates in cooperative UE communications, in accordance with certain aspects of the present disclosure.

FIG. 6 is a call flow diagram illustrating example broadcast signaling of availability information and assistance information for UE discovery, in accordance with certain aspects of the present disclosure.

FIG. 7 is a call flow diagram illustrating example dedicated signaling of availability information and assistance information for UE discovery, in accordance with certain aspects of the present disclosure.

FIGS. 8A-8C illustrate an example scenario where a new cooperation connection is established for a target UE in response to detecting a trigger event at the target UE, in accordance with certain aspects of the present disclosure.

FIG. 9 is a call flow diagram illustrating example dedicated signaling for establishing a new cooperation connection for a target UE in response to detecting a trigger event at the target UE, in accordance with certain aspects of the present disclosure.

FIGS. 10A-10C illustrate an example scenario where a new cooperation connection is established for a target UE in response to detecting a trigger event at a cooperative UE, in accordance with certain aspects of the present disclosure.

FIG. 11 is a call flow diagram illustrating example dedicated signaling for establishing a new cooperation connection for a target UE in response to detecting a trigger event at a cooperative UE, in accordance with certain aspects of the present disclosure.

FIG. 12 is a flow diagram illustrating example operations 1200 for wireless communication by a target user equipment (UE), in accordance with certain aspects of the present disclosure.

FIG. 13 is a flow diagram illustrating example operations 1300 for wireless communication by a cooperative candidate UE, in accordance with certain aspects of the present disclosure.

FIG. 14 depicts aspects of an example communications device, in accordance with certain aspects of the present disclosure.

### DETAILED DESCRIPTION

Aspects of the present disclosure provide apparatuses, methods, processing systems, and computer-readable mediums for user equipment (UE) discovery for UE cooperation in wireless communication networks.

Employing UE cooperation in wireless communication networks may help provide mobility support to UEs in networks with limited energy and radio spectrum resources. UE cooperation generally refers to the ability of UEs to share resources. For example, a cooperating UE may help to increase the effective capability of another UE, referred to herein as a target UE. Collectively, the cooperating UE and target UE may form a virtual UE with greater capability than either of the UEs have separately. Such UE coordination may provide benefits, including improved spatial diversity, improved resource utilization, and improved throughput.

While UE cooperation may provide such benefits, UE cooperation may come with various challenges. For example, one challenge may be in discovering cooperative candidate UE(s). In other words, it may be challenging to identify cooperative candidate UEs that are capable of serving as cooperating UEs. Another challenge may be in establishing cooperation connection(s) with the discovered cooperative candidate UE(s). For example, a target UE seeking to cooperate with one or more cooperative candidate UEs may not have the necessary information to cooperate with these UEs nor sufficient knowledge of cooperative candidate UEs' availability to cooperate.

Aspects of the present disclosure described herein may help to mitigate such challenges. For example, according to aspects described herein, one or more cooperative candidate UEs may facilitate UE discovery, by the target UE, for establishing a cooperation connection by providing availability information, and in some cases, assistance information, to the target UE. The availability information and assistance information may assist the target UE in UE discovery, and for establishing cooperation connection(s) between the target UE and at least one of the one or more cooperative candidate UEs.

As a result, the techniques presented herein may help to identify cooperating candidate UE and, once identified, to establish a connection with such candidates. In this manner, UEs utilizing the techniques described herein may experience improved performance and increased quality of service.

### Introduction to Wireless Communication Networks

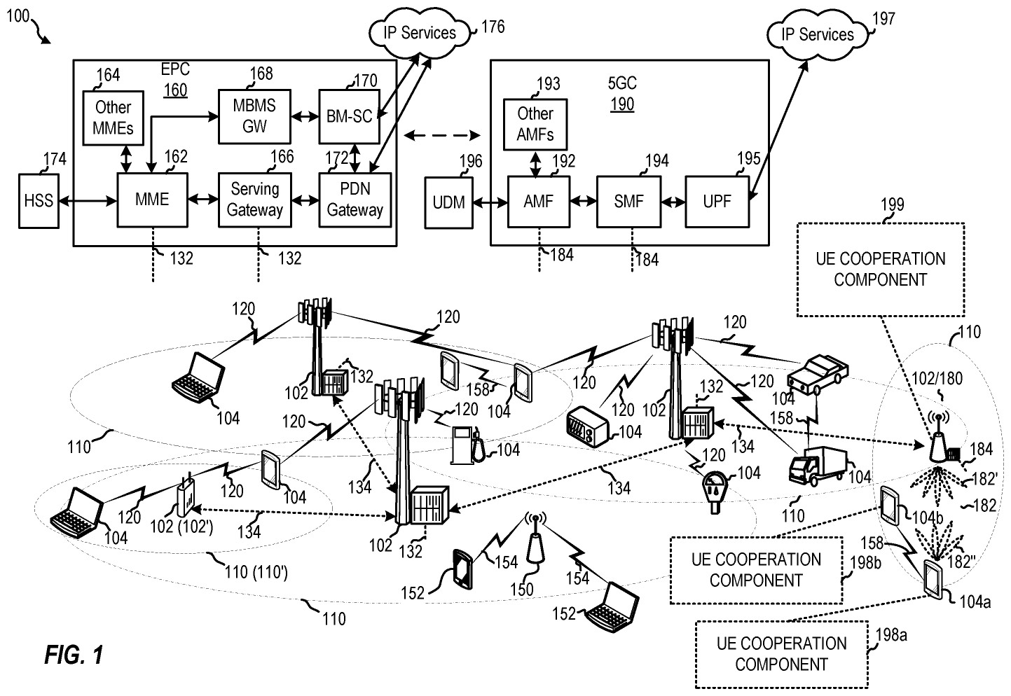

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from BS 180 in one or more receive directions 182″. UE 104 may also transmit a beamformed signal to the base station 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communication network 100 includes UE cooperation component 199, which may configure one or more aspects of UE discovery for UE cooperation, by UEs 104. Wireless communication network 100 further includes UE cooperation component 198 (e.g., UE cooperation component 198a and UE cooperation component 198b), which may be used by UEs 104 to discover and establish cooperation connections between target UEs 104 and candidate UEs 104.

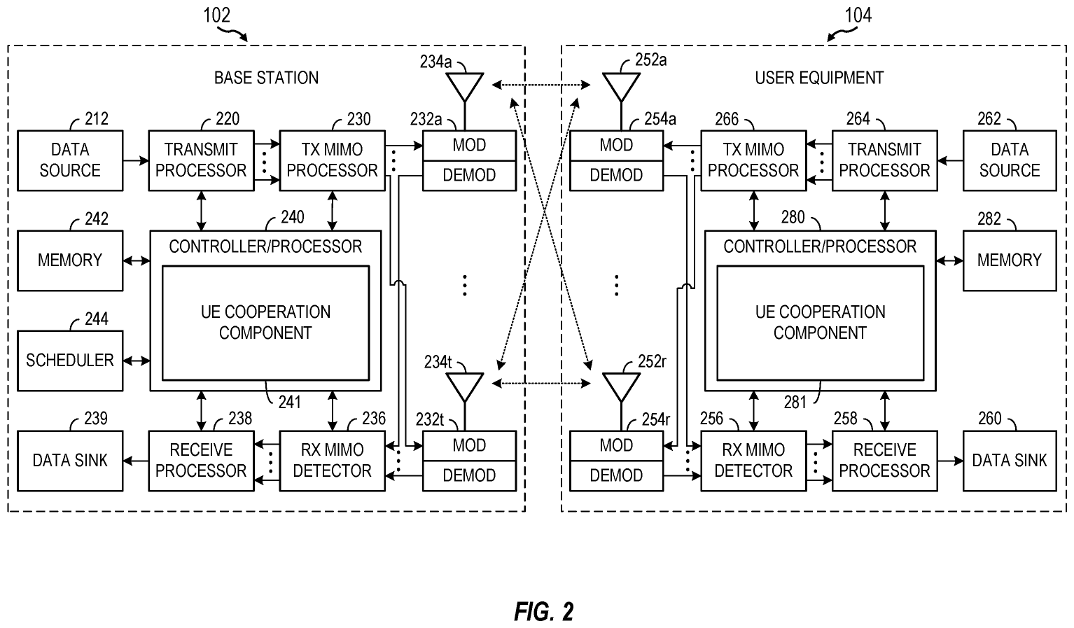

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes UE cooperation component 241, which may be representative of UE cooperation component 199 of FIG. 1. Notably, while depicted as an aspect of controller/processor 240, UE cooperation component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes UE cooperation component 281, which may be representative of UE cooperation component 198 (e.g., UE cooperation component 198a and UE cooperation component 198b) of FIG. 1. Notably, while depicted as an aspect of controller/processor 280, UE cooperation component 281 may be implemented additionally or alternatively in various other aspects of UE 104 in other implementations.

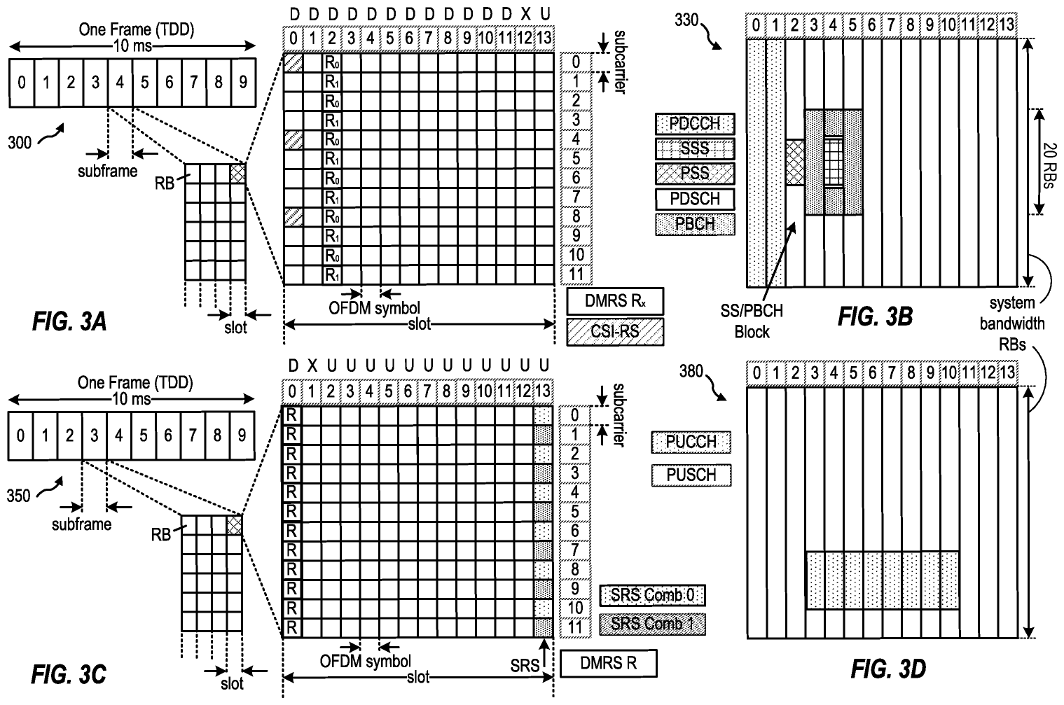

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Introduction to User Equipment (UE) Cooperation

The idea of employing cooperation in wireless communication networks has emerged in response to user mobility support and limited energy and radio spectrum resources, which pose challenges in the development of wireless communication networks and services in terms of capacity and performance.

Cooperative wireless communication may involve a wireless network where wireless agents, e.g., user equipments (UEs), increase their effective quality of service (measured at the physical (PHY) layer by bit error rates, block error rates, or outage probability) via cooperation. In a cooperative communication system, each UE is assumed to transmit data as well as act as a cooperative agent for another UE.

Mobile wireless channels suffer from fading, meaning that signal attenuation can vary significantly over the course of a given transmission. By transmitting independent copies of a signal, cooperating UEs may combat the deleterious effects of fading through signal diversity. In particular, spatial diversity may be generated by transmitting signals from different locations, thus allowing independently faded versions of the signal at the receiver. However, many wireless devices (including UEs) may be limited by size and/or cost to reduced processing resources (e.g., limited to one antenna). Accordingly, cooperative communication has been proposed to enable devices, such as single antenna UEs, in a multi-user environment to share their antennas and generate a virtual multiple-antenna transmitter (e.g., a virtual UE) that allows the UEs to achieve spatial diversity. This may represent increased resource utilization. In other words, idle UEs cooperate with active UEs to create a single virtual UE in order to utilize full network throughput.

For example, for cooperative communication, two UEs may be communicating with a same network entity (e.g., a base station). Each UE has one antenna and cannot individually generate spatial diversity. However, it may be possible for one UE to receive information from the other UE, in which case the receiving UE can forward some version of the information from the other UE along with its own data to the network entity. Because the fading paths from two UEs are statistically independent, this generates spatial diversity. Further, a cooperative link established between the two UEs may use unlicensed spectrum to ensure all licensed spectrum remains available to the network.

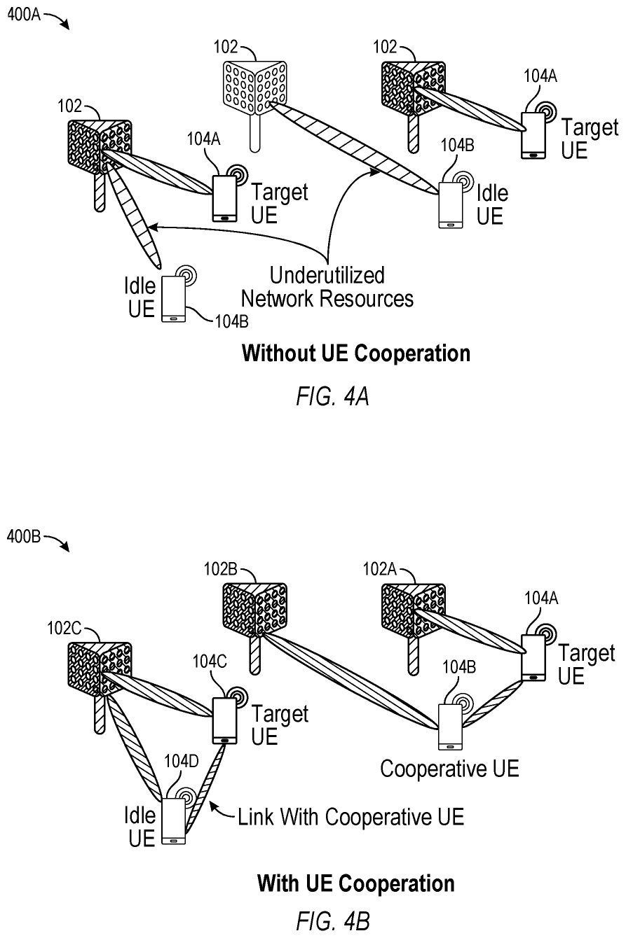

FIG. 4A illustrates an example wireless communications network 400A without UE cooperation, in accordance with certain aspects of the present disclosure. As shown in FIG. 4A, a target UE (e.g., such as UE 104a illustrated in wireless communication network 100 of FIG. 1) and an idle UE (e.g., such as UE 104b illustrated in wireless communication network 100 of FIG. 1) may each communicate with a network entity (e.g., such as BS 102 illustrated in wireless communication network 100 of FIG. 1). As shown, however, because target UE 104a and idle UE 104b do not establish a cooperative link between each other, in this example, network resources may be under-utilized, and thus, throughput may be limited.

In contrast, FIG. 4B illustrates an example wireless communications network 400B with UE cooperation, in accordance with certain aspects of the present disclosure. In the example shown in FIG. 4B, target UE 104a and cooperative UE 104b may establish a cooperation connection to utilize full network throughput. Further, as described above, the link between target UE 104a and cooperative UE 104b may allow for use of unlicensed spectrum.

In certain aspects, cooperative UE updates (as well as UE capability updates) may be transparent to a network entity (e.g., gNB), such as in physical layer (PHY, Layer 1, or L1) or medium access control (MAC) layer (Layer 2 or L2) based solutions. For example, a cooperative UE (e.g., a UE which had previously established a cooperation connection with a target UE) may be removed and/or a cooperation candidate UE may establish a cooperation connection with a target UE (e.g., causing the cooperation candidate UE to be a cooperative UE with the target UE) without the network entity's awareness.

In this case, a multiple-transmission reception point (multi-TRP) framework may be used. In other words, cooperating UEs may access wireless networks via multiple TRPs to help support increased mobile data traffic and enhance the coverage. Multi-TRPs may be used to implement one or more macro-cells, small cells, pico-cells, or femto-cells, and may include remote radio heads, relay nodes, and the like.

In certain other aspects, UE capability updates may be reported to the network entity in higher layer (e.g., Layer 3 or L3 or higher layer) based solutions. For example, in such cases, a cooperative UE may not be removed and/or a cooperation candidate UE may not establish a cooperation connection with a target UE without the network entity's awareness. In this case, a UE capability update reported to the network entity may be UE-controlled. For example, a target UE may select a cooperative candidate UE to establish a cooperation connection with. The target UE may establish a cooperation connection with the selected cooperative candidate UE to create a single virtual UE. The target UE may then transmit a capability update to the network entity, to reflect the additional capability of the virtual UE (relative to the target UE alone).

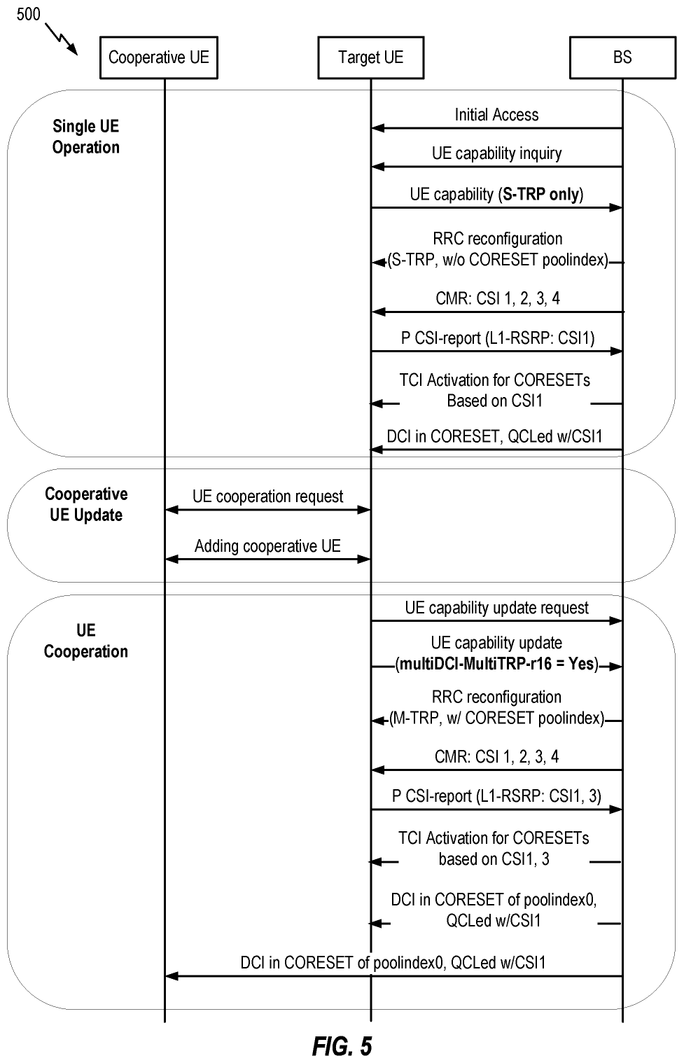

The call flow diagram 500 of FIG. 5 illustrates example signaling for UE capability updates in cooperative UE communications, in accordance with certain aspects of the present disclosure.

As illustrated, a target UE (e.g., such as UE 104a illustrated in wireless communication network 100 of FIG. 1) may initially establish a connection with a gNB (e.g., such as BS 102 illustrated in wireless communication network 100 of FIG. 1), initially acting in a single UE operation mode. In this example, the target UE may be a 3GPP Release 15 legacy UE supporting only single TRP (s-TRP) operations. The gNB may learn of the UE's capability (e.g., the UE's ability to support s-TRP operations) by transmitting a UE capability inquiry to the target UE, and the target UE may respond to the gNB accordingly (e.g., indicating S-TRP operations capability only). Based on the reported capability for the target UE, the gNB may initiate a radio resource control (RRC) reconfiguration for S-TRP operation (e.g., no CORESETPoolIndex is configured).

Further, as shown in FIG. 5, the gNB may transmit channel state information reference signals (CSI-RS) on various configured channel measurement resources (CMRs (CSI 1, 2, 3, 4 in this example) to the target UE for performing channel measurement. Accordingly, the UE may provide a periodic channel state information (P CSI) report (e.g., containing the L1 reference signal received power (RSRP) and CSI1) to the gNB. Based on this information in the received CSI report, the gNB may provide signaling for TCI activation for CORSETs based on CSI1 and further transmit a downlink control information (DCI) in the CORESET, quasi-co-located (QCLed) with CSI1.

In certain aspects, as shown in FIG. 5, the target UE may discover an idle UE that may aid in the target UE's communication with the gNB (e.g., also referred to herein as a cooperative candidate UE). Accordingly, after discovering the cooperative candidate UE, the UE may transmit a UE cooperation request to the UE and establish a cooperation connection with the cooperative candidate UE to create a virtual UE.

The UE capability of the virtual UE may be an aggregation of capabilities for the target UE and the cooperative candidate UE. In this case, it may be assumed that the virtual UE is capable of support multi-TRP operations. Given the target UE only supported single TRP operation prior to the aggregation, the updated UE capability (e.g., from single-TRP operation capability to multi-TRP operation capability) may be reported to the gNB. As shown, the target UE may transmit, to the gNB, a UE capability update request to prompt transmission of a UE capability inquiry by the gNB. In response, the target UE may provide an indication to the gNB as to the updated UE capability for the virtual UE. The gNB may reconfigure the RRC for the virtual UE based on the new UE capability reported to the gNB.

As noted above, while UE cooperation may provide many benefits, including spatial diversity and full network throughput utilization, there may be many challenges in (1) discovering a cooperative candidate UE and (2) establishing a cooperation connection with the discovered cooperative candidate UE.

For example, one challenge may be due to the potential diversity of sidelink support of UE cooperation (meaning there are many possible sets of parameters for sidelink communication with a candidate coordinating UE). Accordingly, for a target UE to establish a sidelink connection with a cooperative candidate UE for forming a cooperation connection, the target UE may require some additional, initial information. Such information may include sidelink configurations for discovering certain cooperative candidate UEs.

As another example challenge, in some cases, sidelink may not support the exchange of certain types of information between a cooperative candidate UE and a target UE. In particular, the cooperative candidate UE may have previously established a connection with the gNB. The cooperative candidate UE may transmit information, such as a maximum permissible exposure (MPE) report, to the gNB directly, without also transmitting such information to the target UE.

As another example challenge, a cooperative candidate UE may be configured with discontinuous reception (DRX) cycles unknown to the target UE. In particular, in a DRX mode of operation, the cooperative candidate UE may enter a low power (“sleep”) mode, which may also be referred to as a sleep phase or low power state, for a certain period of time (referred to as a DRX OFF duration) and wake up again during a DRX ON duration to determine if there is any data to be received. The cycle of DRX ON and DRX OFF durations repeat periodically over time, allowing the cooperative candidate UE to save power while maintaining communication. Without knowing the DRX cycles configured for the cooperative candidate UE, however, the target UE may experience difficulty in identifying suitable time occasions for establishing a cooperation connection with the cooperative candidate UE.

### Aspects Related to User Equipment (UE) Discovery for UE Cooperation

Aspects of the present disclosure provide techniques and apparatuses for user equipment (UE) discovery for UE cooperation in wireless communications that may help overcome various challenges of current UE discovery where cooperative UE communications.

According to aspects described herein, to facilitate a target UE in (candidate cooperating) UE discovery, one or more cooperative candidate UEs may provide UE availability information (also referred to herein as “availability information”). In some cases, cooperative candidate UEs may also provide UE assistance information (also referred to herein as “assistance information”) to the target UE. The availability information and assistance information may assist the target UE in UE discovery for establishing cooperation connection(s) between the target UE and at least one of the one or more cooperative candidate UEs. Further, aspects described herein provide techniques for reporting updated UE capabilities to a network entity based on one or more cooperation connections established by the target UE.

In certain aspects, at least one of the availability information or the assistance information is received by a target UE via broadcast signaling from the one or more candidate UEs. Broadcast signaling may be used by a cooperative candidate UE, for example, where the cooperative candidate UE is willing to cooperate other UEs' communication. A target UE receiving such broadcast signaling may determine whether the target UE is willing to establish a cooperation connection with this cooperative candidate UE. If so, the target UE may establish the cooperation connection, using the received availability information and/or assistance information.

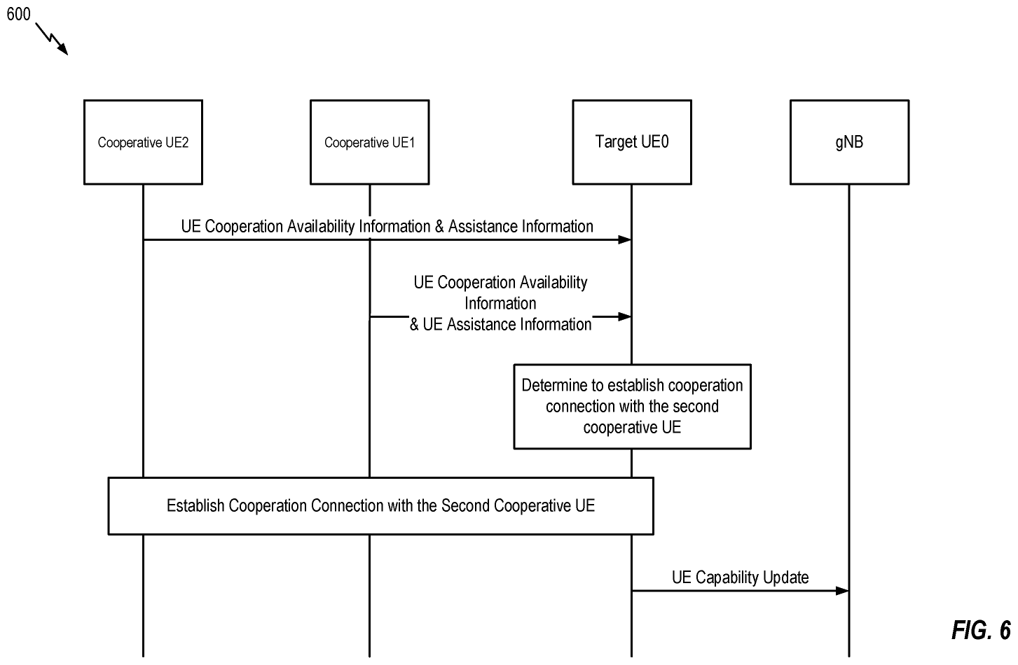

FIG. 6 is a call flow diagram 600 illustrating example (broadcast) signaling of availability information and assistance information for UE discovery, in accordance with certain aspects of the present disclosure. As illustrated in FIG. 6, a first cooperative candidate UE (UE1) (e.g., such as UE 104b illustrated in wireless communication network 100 of FIG. 1) and a second cooperative candidate UE (UE2) (e.g., another UE 104 in wireless communication network 100 of FIG. 1) may be UEs capable of (and willing to) cooperate other UEs' communication. Accordingly, both of UE1 and UE2 may transmit availability information and assistance information via broadcast signaling. A listening target UE (UE0) (e.g., such as UE 104b illustrated in wireless communication network 100 of FIG. 1) may receive the availability information and the assistance information from each of UE1 and UE2.

In certain aspects, the assistance information from UE1 includes at least one of: a supported sidelink type, a supported sidelink latency, a supported access (Uu) link or an uplink (UL) maximum transmit power. Similar assistance information may be broadcast by UE2.

In certain aspects, the assistance information from UE1 includes location information of UE1 or an indication of a status of a Uu link of UE1. The indication of the status of the Uu link may include at least one of: a maximum permissible exposure (MPE) event report, a power headroom reports (PHR), or a channel state information (CSI) report. Similar assistance information may be broadcast by UE2.

In certain aspects, the assistance information from UE1 indicates at least one of: time windows when UE1 is available to cooperate with UE0, wherein durations are specified for each of the time windows or discontinuous reception (DRX) cycles configured for UE1. Similar assistance information may be broadcast by UE2.

In certain aspects, each of UE1 and UE2 are configured to broadcast their availability information and assistance information periodically (e.g., periodical transmit to UE0).

Although the example of FIG. 6 illustrates two cooperative candidate UEs broadcasting availability information and assistance information, any number of cooperative candidate UEs may broadcast such information, where such cooperative candidate UEs are willing to cooperate other UEs' communication.

After receiving such information, UE0 may determine to establish a cooperation connection with UE2.

In certain aspects, UE0 may make this determination based on the received availability information and the received assistance information from each of UE1 and UE2. In certain aspects, UE0 may make this determination based on a capability of each of UE1 and UE2. While the example of FIG. 6 illustrates UE0 determining to establish a cooperation connection with tUE2, in certain other embodiments, UE0 may determine to establish a cooperation connection with UE1, both of UE1 and UE2, or neither of UE1 or UE2.

UE0 may use the assistance information received from UE2 to establish a cooperation connection with UE2. After establishing this connection, the effective capability of a resulting virtual UE (e.g., the combination of UE0 and UE2) may be an aggregation of capabilities of UE0 and UE2.

UE0 may need to provide the gNB with a UE capability update, to reflect the change in capability associated with the virtual UE. The UE capability update may indicate to the gNB the capability information for the virtual UE. More specifically, when a cooperation connection is added or dropped with UE0, UE0 may transmit to the gNB an updated indication of UE capability based on the added or dropped cooperation connection.

While FIG. 6 illustrates broadcast signaling of the availability information and the assistance information, in certain other aspects, at least one of the availability information or the assistance information is received by UE0 via dedicated signaling from the one or more cooperative candidate UEs, upon receipt of a dedicated UE cooperation request at each of the one or more cooperative candidate UEs.

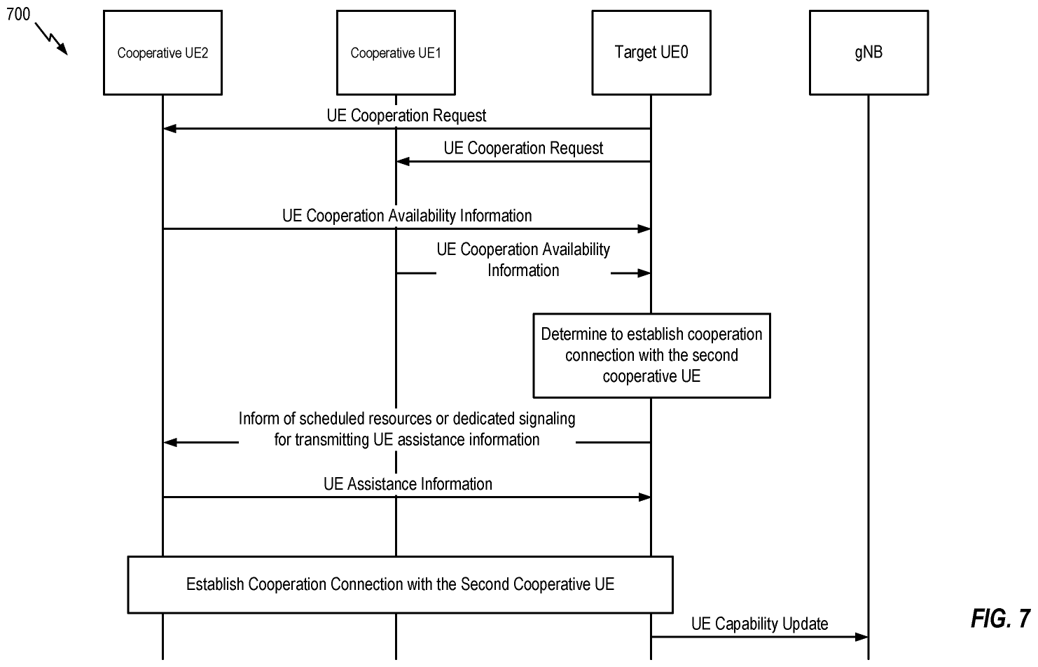

FIG. 7 is a call flow diagram 700 illustrating example dedicated signaling of availability information and assistance information for UE discovery, in accordance with certain aspects of the present disclosure.

As illustrated in FIG. 7, UE0 may transmit a request to UE1 and/or UE2 for availability information and assistance information from each of the cooperative candidate UEs. In response to receiving the requests, both of tUE1 and UE2 may transmit availability information to UE0.

In certain aspects, the availability information from each of UE1 and UE2 may indicate to UE0 whether each of UE1 and UE2 are able, and willing, to cooperate UE communication. In some cases, the availability information may be an acknowledgement (ACK) or negative ACK (NACK) in response to UE0's UE cooperation request. In certain aspects, the availability information may be transmitted via dedicated signaling, such as, at least one of, a medium access control (MAC)-control element (CE) or a physical sidelink shared channel (PSSCH).

Although the example of FIG. 7 illustrates UE0 transmitting a UE cooperation request to two cooperative candidate UEs, UE0 may transmit the UE capability request to any number of cooperative candidate UEs, and accordingly receive availability information from each of these cooperative candidate UEs which received the request.

After receiving such availability information, UE0 may determine to establish a cooperation connection with UE2. In certain aspects, UE0 may make this determination based on the received availability information from each of UE1 and UE2. While the example of FIG. 7 illustrates UE0 determining to establish a cooperation connection with UE2, in certain other embodiments, UE0 may determine to establish a cooperation connection with UE1, both of UE1 and UE2, or neither of UE1 or UE2.

Accordingly, Ue0 may inform UE2 of scheduled resources or dedicated signaling for transmitting UE assistance information. UE2 may transmit the UE assistance information using the scheduled resource or the indicated dedicated signaling. For example, the UE assistance information may be transmitted via a MAC-CE or via a PSSCH.

In certain aspects, the assistance information from UE2 includes at least one of: a supported sidelink type, a supported sidelink latency, a supported Uu link, or UL maximum transmit power. In certain aspects, the assistance information from UE2 includes location information of UE2 or an indication of a status of a Uu link of UE2. The indication of the status of the Uu link may include at least one of: an MPE event report, a PHR, or a CSI report. In certain aspects, the assistance information from UE2 indicates at least one of: time windows when UE2 is available to cooperate with UE0, wherein durations are specified for each of the time windows, or DRX cycles configured for UE2.

UE0 may use the assistance information received from UE2 to establish a cooperation connection with UE2. Accordingly, the capability of a virtual UE (e.g., the combination of UE0 and UE2) may be an aggregation of capabilities of UE0 and UE2.

Because in this example, UE0 did not previously have a cooperation connection established with another UE, the original UE capability information reported to the gNB was the capability information for UE0, alone. Accordingly, now that UE0 and UE2 have established a cooperation connection, UE0 may need to provide the gNB with a UE capability update. The UE capability update may indicate to the gNB the capability information for the virtual UE.

In certain aspects, UE0 may transmit a UE cooperation request (e.g., as shown in FIG. 7) to one or more cooperative candidate UEs in response to detecting a trigger event. In certain aspects, the trigger event involves an MPE for a link between the network entity (e.g., gNB) and UE0 or a cooperative UE being above a first threshold. In certain aspects, the trigger event involves measured CSI for the link between the network entity and the target UE or the cooperative UE being below a second threshold. The first and second thresholds may be values greater than zero. The first and second thresholds may be preconfigured or dynamically indicated. The first threshold may be different than the second threshold.

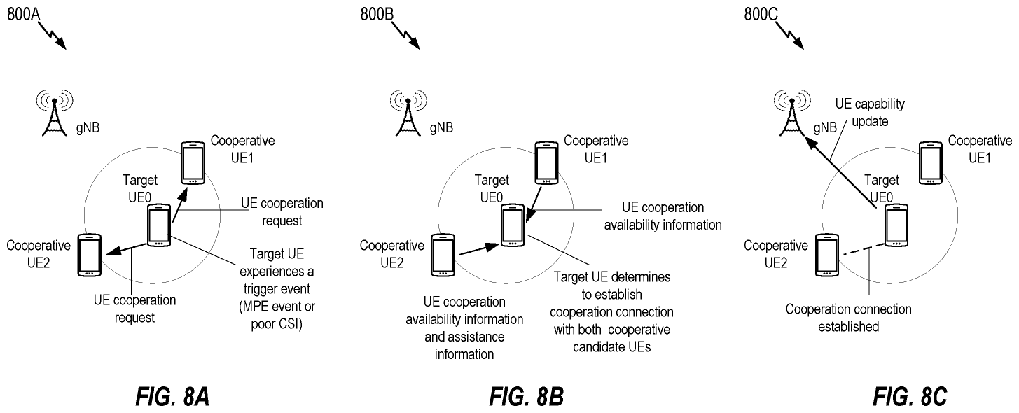

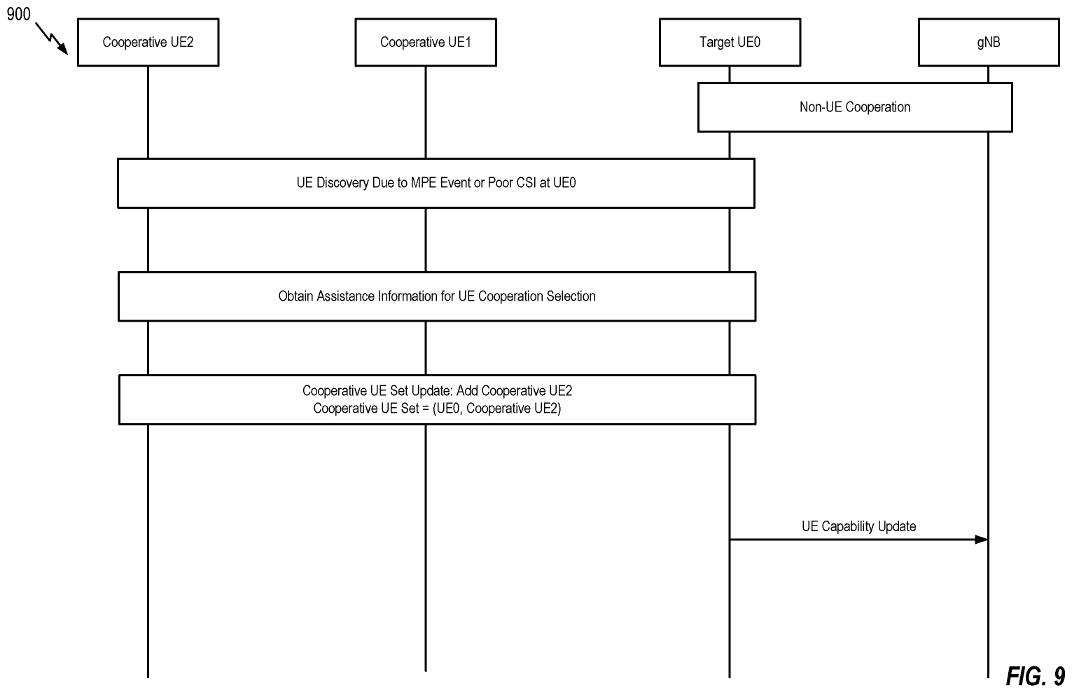

FIGS. 8A-8C illustrate an example scenario 800A-800C where a new cooperation connection is established for UE0 in response to detecting a trigger event at UE0, in accordance with certain aspects of the present disclosure. FIG. 9 is a call flow diagram 900 illustrating example dedicated signaling for establishing a new cooperation connection for UE0 in response to detecting a trigger event at UE0, in accordance with certain aspects of the present disclosure.

For example scenario 800A-800C and call flow diagram 900, UE0 may have previously established a connection with a gNB. Further, in this example, UE0 may not have previously established any cooperation connections with other UEs.

As shown in FIG. 8A and FIG. 9, UE0 may, in some cases, experience a trigger event. For example, an MPE for a link between UE0 and the gNB may be above a first threshold. Additionally, or in the alternative, measured CSI for the link between UE0 and the gNB may be below a second threshold. Based on either, or both of these scenarios, UE0 may transmit a request (e.g., a UE cooperation request) to UE1 and UE2 for availability information and assistance information from each of UE1 and UE2. In response to receiving the requests, both of UE1 and UE2 may transmit availability information to UE0.

After receiving such availability information, as illustrated in FIG. 8B and FIG. 9, UE0 may determine to establish a cooperation connection with UE2. Accordingly, UE0 may inform UE2 of scheduled resources or dedicated signaling for transmitting UE assistance information. UE2 may transmit the UE assistance information using the scheduled resources or the indicated dedicated signaling.

UE0 may use the assistance information received from UE2 to establish a cooperation connection with UE2, as illustrated in FIG. 8C and FIG. 9. Accordingly, the capability of a virtual UE (e.g., the combination of UE0 and UE2) may be an aggregation of capabilities of UE0 and UE2.

Because, in this example, UE0 did not previously have a cooperation connection established with another UE, UE0 may provide the gNB with a UE capability update, as illustrated in FIG. 8C and FIG. 9. The UE capability update may indicate to the gNB the capability information for the virtual UE.

In some cases, a target UE operating with a current cooperative UE set (including the target UE and a current cooperative UE) may select a different cooperative UE set. For example, due to an event (MPE or bad CSI) at the target UE and the current cooperative UE, the target UE may seek other cooperative candidate UEs (to form a better cooperative UE set).

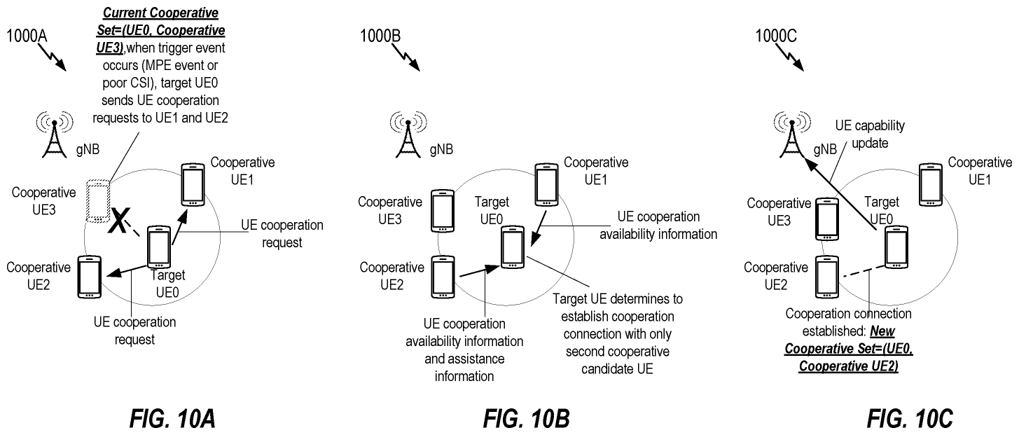

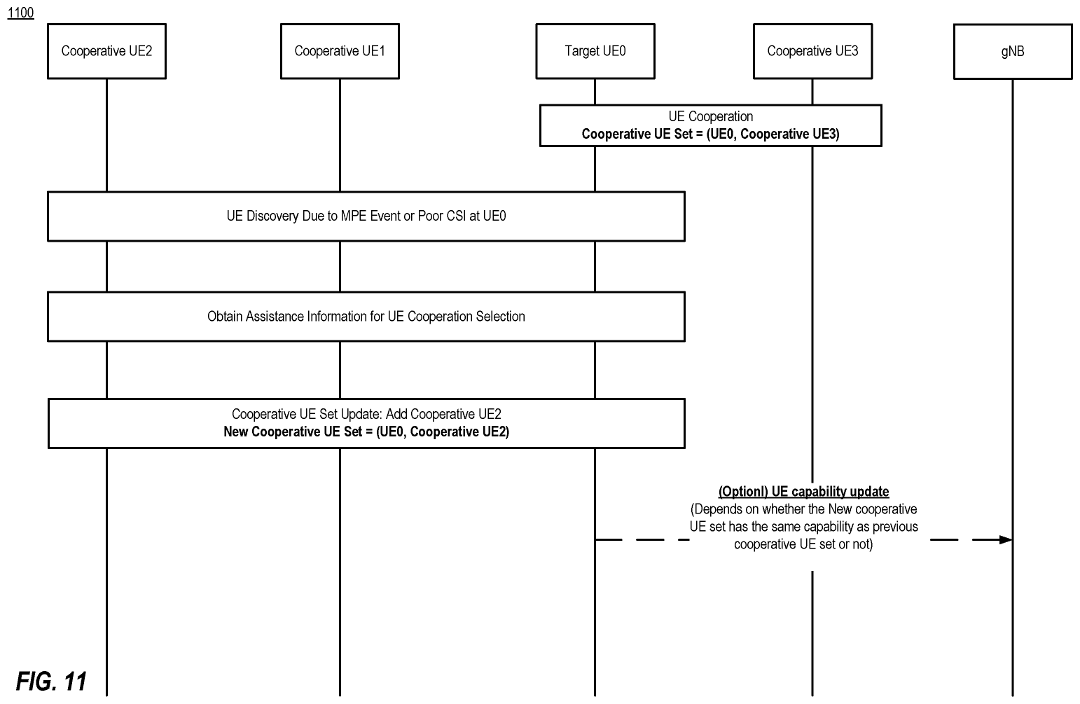

FIGS. 10A-10C illustrate an example scenario 1000A-1000C where a new cooperation connection is established for UE0 in response to detecting a trigger event at a cooperative UE (e.g., cooperative UE3), in accordance with certain aspects of the present disclosure. FIG. 11 is a call flow diagram 1100 illustrating how UE0 may select an updated cooperative UE set, in response to detecting a trigger event while cooperating with a current cooperative UE, UE3.

For example, in scenario 1000A-1000C and call flow diagram 1100, UE0 may have previously established a connection with a gNB. Further, in this example, UE0 may have previously established a cooperation connection with UE3, as illustrated in FIG. 10A and FIG. 11. In other words, initially, the current cooperative UE set includes UE0 and UE3.

Further, as shown in FIG. 10A and FIG. 11, UE0 (and/or UE3) may experience a trigger event (e.g., an MPE event or bad CSI between target UE0 and cooperative UE3). In response to the trigger event, UE0 may seek to select a new cooperative UE set. Accordingly, UE0 may transmit a UE cooperation request to cooperative candidates UE1 and UE2. In response to receiving the requests, UE1 and UE2 may transmit availability information to UE0.

After receiving such availability information, as illustrated in FIG. 10B and FIG. 11, UE0 may determine to establish a cooperation connection with one or both of UE1 or UE2. In the illustrated example, UE0 establishes a connection with UE2. In other words, the cooperative UE set is updated by adding UE2.

As illustrated in FIG. 11, whether UE0 sends a capability update may depend on whether the (aggregate) capability of the new cooperative UE set (UE0 and UE2) is different than the capability of the previous cooperative UE set (UE0 and UE3). If there is no change in capability, there may be no need to send an update.

### Example Operations

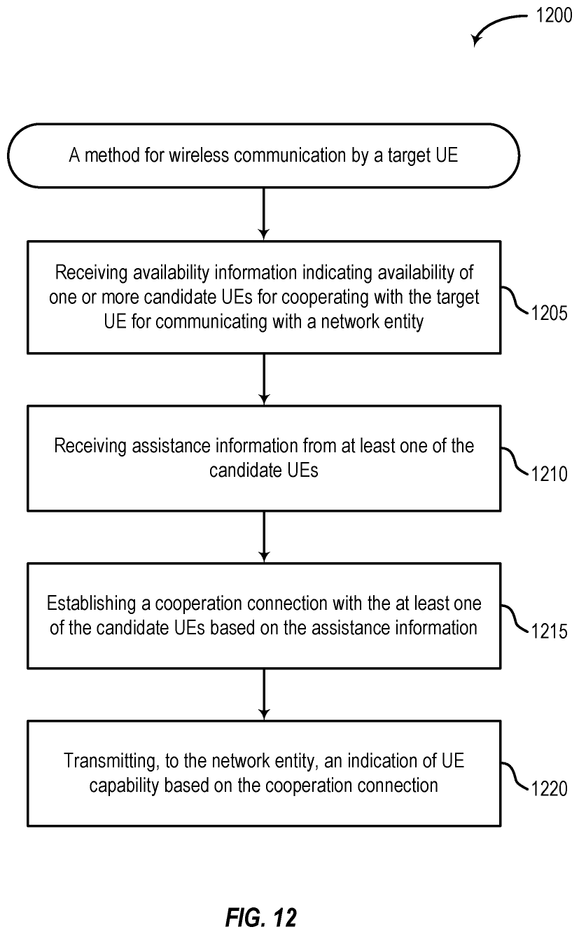

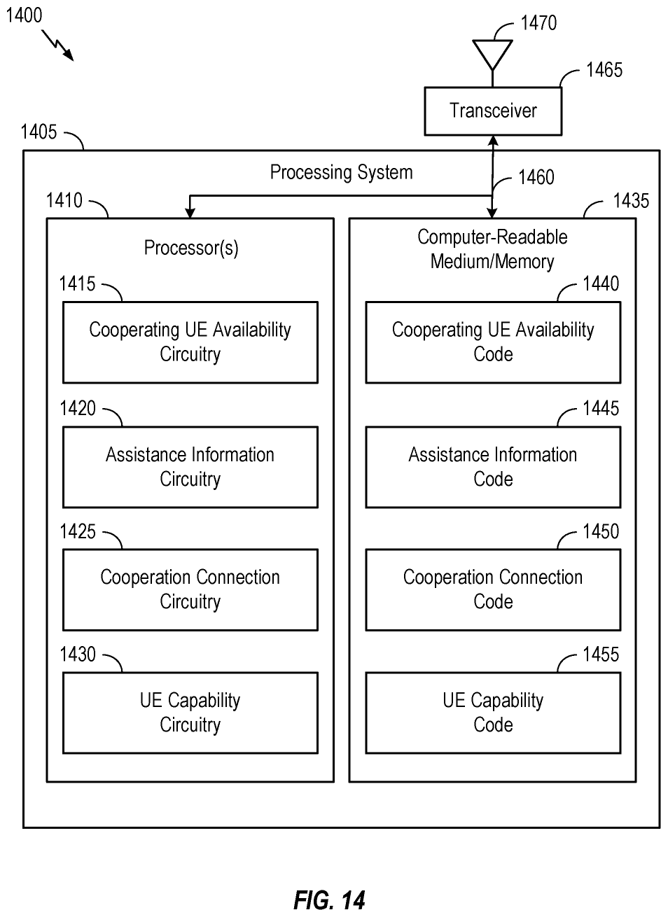

FIG. 12 shows an example of a method 1200 for wireless communication according to aspects of the present disclosure. In some aspects, a user equipment, such as UE 104 of FIGS. 1 and 2, or processing system 1405 of FIG. 14, may perform the method 1200.

Method 1200 begins at step 1205 with receiving availability information indicating availability of one or more candidate UEs for cooperating with the target UE for communicating with a network entity. In some cases, the operations of this step refer to, or may be performed by, cooperating UE availability circuitry as described with reference to FIG. 14.

Method 1200 then proceeds to step 1210 with receiving assistance information from at least one of the candidate UEs. In some cases, the operations of this step refer to, or may be performed by, assistance information circuitry as described with reference to FIG. 14.

Method 1200 then proceeds to step 1215 with establishing a cooperation connection with the at least one of the candidate UEs based on the assistance information. In some cases, the operations of this step refer to, or may be performed by, cooperation connection circuitry as described with reference to FIG. 14.

Method 1200 then proceeds to step 1220 with transmitting, to the network entity, an indication of UE capability based on the cooperation connection. In some cases, the operations of this step refer to, or may be performed by, UE capability circuitry as described with reference to FIG. 14.

In some aspects, the assistance information comprises at least one of: a supported sidelink type; a supported sidelink latency; a supported access (Uu) link; or UL maximum transmit power.

In some aspects, the assistance information comprises at least one of: location information of the at least one candidate UE; or an indication of a status of an access link of the candidate UE. In some aspects, the indication of the status of the access link comprises at least one of: a MPE event report; a PHR; or a CSI report.

In some aspects, the assistance information indicates at least one of: time windows when the candidate UE is available to cooperate with the target UE, wherein durations are specified for each of the time windows; or DRX cycles configured for the candidate UE.

In some aspects, at least one of the availability information or the assistance information is received via broadcast signaling from the one or more candidate UEs. In some aspects, the broadcast signaling is broadcast periodically.

In some aspects, the method 1200 further includes transmitting a request to the at least one of the candidate UE for the assistance information; and receiving the assistance information in response to the request. In some aspects, the request is transmitted in response to detecting a trigger event. In some aspects, the trigger event involves at least one of: an MPE for a link between the network entity and the target UE or a cooperative UE is above a first threshold; or measured CSI for the link between the network entity and the target UE or a cooperative UE is below a second threshold.

In some aspects, at least one of the availability information or the assistance information is received via dedicated signaling from the one or more candidate UEs. In some aspects, the dedicated signaling comprises at least one of: a MAC-CE or a PSSCH. In some aspects, the dedicated signaling is transmitted based on a trigger event.

In some aspects, the method 1200 further includes adding or dropping a cooperation connection with at least one of the candidate UEs; and transmitting, to a network entity, an updated indication of UE capability based on the added or dropped cooperation connection.

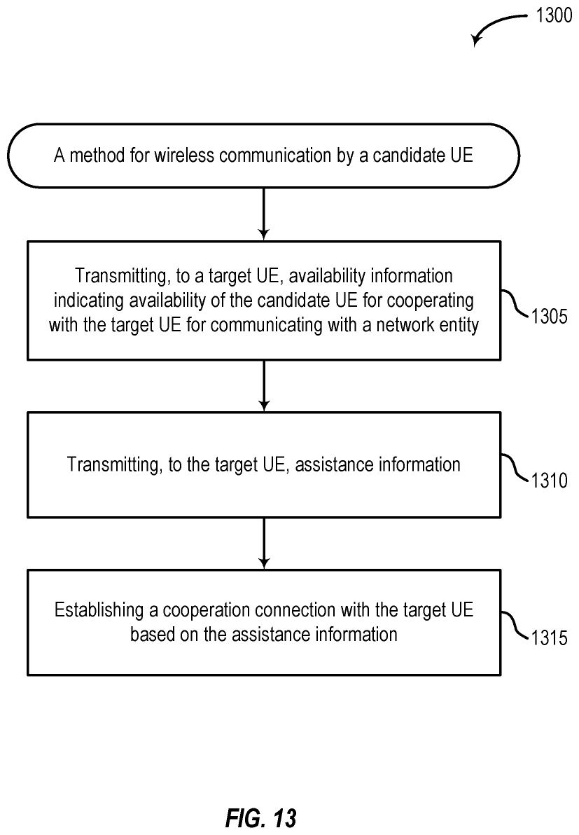

FIG. 13 shows an example of a method 1300 for wireless communication according to aspects of the present disclosure. In some aspects, a base station, such as BS 102 of FIGS. 1 and 2, or processing system 1405 of FIG. 14, may perform the method 1300.

Method 1300 begins at step 1305 with transmitting, to a target UE, availability information indicating availability of the candidate UE for cooperating with the target UE for communicating with a network entity. In some cases, the operations of this step refer to, or may be performed by, cooperating UE availability circuitry as described with reference to FIG. 14.

Method 1300 then proceeds to step 1310 with transmitting, to the target UE, assistance information. In some cases, the operations of this step refer to, or may be performed by, assistance information circuitry as described with reference to FIG. 14.

Method 1300 then proceeds to step 1315 with establishing a cooperation connection with the target UE based on the assistance information. In some cases, the operations of this step refer to, or may be performed by, cooperation connection circuitry as described with reference to FIG. 14.

In some aspects, the assistance information comprises at least one of: a supported sidelink type; a supported sidelink latency; a supported access (Uu) link; or UL maximum transmit power.

In some aspects, the assistance information comprises at least one of: location information of the candidate UE or an indication of a status of an access link of the candidate UE. In some aspects, the indication of the status of the access link comprises at least one of: a MPE event report; a PHR; or a CSI report.

In some aspects, the assistance information indicates at least one of: time windows when the candidate UE is available to cooperate with the target UE, wherein durations are specified for each of the time windows; or DRX cycles configured for the candidate UE.

In some aspects, at least one of the availability information or the assistance information is transmitted via broadcast signaling to the target UE. In some aspects, the broadcast signaling is broadcast periodically.

In some aspects, the method 1300 further includes receiving, from the target UE, a request for the assistance information; and transmitting the assistance information in response to the request. In some aspects, the request is received in response to a trigger event. In some aspects, the trigger event involves at least one of: an MPE for a link between the network entity and the target UE or a candidate UE is above a first threshold; or measured CSI for the link between the network entity and the target UE or a candidate UE is below a second threshold.

In some aspects, at least one of the availability information or the assistance information is transmitted via dedicated signaling to the target UE. In some aspects, the dedicated signaling comprises at least one of: a MAC-CE or a PSSCH. In some aspects, the dedicated signaling is transmitted based on a trigger event.

In some aspects, the method 1300 further includes adding or dropping a cooperation connection with at least one of the candidate UEs; and transmitting, to a network entity, an updated indication of UE capability based on the added or dropped cooperation connection.

### Example Wireless Communication Devices

FIG. 14 depicts an example communications device 1400 that includes various components operable, configured, or adapted to perform operations for the techniques disclosed herein, such as the operations depicted and described with respect to FIGS. 6, 7, 9, 11, 12, and 13. In some examples, communication device 1400 may be a UE 104 as described, for example with respect to FIGS. 1 and 2.

Communications device 1400 includes a processing system 1405 coupled to the transceiver 1465 (e.g., a transmitter and/or a receiver). The transceiver 1465 is configured to transmit (or send) and receive signals for the communications device 1400 via the antenna 1470, such as the various signals as described herein. The transceiver 1465 may communicate bi-directionally, via the antennas 1470, wired links, or wireless links as described herein. For example, the transceiver 1465 may represent a wireless transceiver and may communicate bi-directionally with another wireless transceiver. The transceiver 1465 may also include or be connected to a modem to modulate the packets and provide the modulated packets to for transmission, and to demodulate received packets. In some examples, the transceiver 1465 may be tuned to operate at specified frequencies. For example, a modem can configure the transceiver 1465 to operate at a specified frequency and power level based on the communication protocol used by the modem.

Processing system 1405 may be configured to perform processing functions for communications device 1400, including processing signals received and/or to be transmitted by communications device 1400. Processing system 1405 includes one or more processors 1410 coupled to a computer-readable medium/memory 1435 via a bus 1460.

In some examples, one or more processors 1410 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof).

In some cases, the one or more processors 1410 are configured to operate a memory array using a memory controller. In other cases, a memory controller is integrated into the one or more processors 1410. In some cases, the one or more processors 1410 are configured to execute computer-readable instructions stored in a memory to perform various functions. In some aspects, one or more processors 1410 include special purpose components for modem processing, baseband processing, digital signal processing, or transmission processing.

In certain aspects, computer-readable medium/memory 1435 is configured to store instructions (e.g., computer-executable code) that when executed by the one or more processors 1410, cause the one or more processors 1410 to perform the operations illustrated in FIGS. 6, 7, 9, 11, 12, and 13, or other operations for performing the various techniques discussed herein.

In one aspect, computer-readable medium/memory 1435 includes cooperating UE availability code 1440, assistance information code 1445, cooperation connection code 1450, and UE capability code 1455.

Examples of a computer-readable medium/memory 1435 include random access memory (RAM), read-only memory (ROM), solid state memory, a hard drive, a hard disk drive, etc. In some examples, computer-readable medium/memory 1435 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1400 may provide means for performing the methods described herein, including with respect to FIGS. 6, 7, 9, 11, 12, and 13.

In some examples, means for transmitting or sending (or means for outputting for transmission) may include transceivers 254 and/or antenna(s) 252 of the UE 104 illustrated in FIG. 2 and/or the transceiver 1465 and the antenna 1470 of the communication device in FIG. 14.

In some examples, means for receiving (or means for obtaining) may include transceivers 254 and/or antenna(s) 252 of the UE 104 illustrated in FIG. 2 and/or the transceiver 1465 and the antenna 1470 of the communication device in FIG. 14.

In some examples, means for **ADD CLAIM VERBS** may include various processing system 1405 components, such as: the one or more processors 1410 in FIG. 14, or aspects of the UE 104 depicted in FIG. 2, including receive processor 258, transmit processor 264, TX MIMO processor 266, and/or controller/processor 280 (including UE cooperation component 281).

In one aspect, one or more processors 1410 includes cooperating UE availability circuitry 1415, assistance information circuitry 1420, cooperation connection circuitry 1425, and UE capability circuitry 1430.

In some aspects, communications device 1400 may be an example of (e.g., may perform operations of) a target UE described herein. According to some aspects, cooperating UE availability circuitry 1415 receives availability information indicating availability of one or more candidate UEs for cooperating with the target UE for communicating with a network entity. According to some aspects, assistance information circuitry 1420 receives assistance information from at least one of the candidate UEs. According to some aspects, cooperation connection circuitry 1425 establishes a cooperation connection with the at least one of the candidate UEs based on the assistance information. According to some aspects, UE capability circuitry 1430 transmits, to the network entity, an indication of UE capability based on the cooperation connection.

In some aspects, the assistance information includes at least one of: a supported sidelink type; a supported sidelink latency; a supported access (Uu) link; or UL maximum transmit power. In some aspects, the assistance information includes at least one of: location information of the at least one candidate UE; or an indication of a status of an access link of the candidate UE. In some aspects, the indication of the status of the access link includes at least one of: a MPE event report; a PHR; or a CSI report. In some aspects, the assistance information indicates at least one of: time windows when the candidate UE is available to cooperate with the target UE, where durations are specified for each of the time windows; or DRX cycles configured for the candidate UE. In some aspects, at least one of the availability information or the assistance information is received via broadcast signaling from the one or more candidate UEs. In some aspects, the broadcast signaling is broadcast periodically.

In some examples, assistance information circuitry 1420 transmits a request to the at least one of the candidate UE for the assistance information. In some examples, assistance information circuitry 1420 receives the assistance information in response to the request. In some aspects, the request is transmitted in response to detecting a trigger event. In some aspects, the trigger event involves at least one of: an MPE for a link between the network entity and the target UE or a cooperative UE is above a first threshold; or measured CSI for the link between the network entity and the target UE or a cooperative UE is below a second threshold.

In some aspects, at least one of the availability information or the assistance information is received via dedicated signaling from the one or more candidate UEs. In some aspects, the dedicated signaling includes at least one of: a MAC-CE or a PSSCH. In some aspects, the dedicated signaling is transmitted based on a trigger event.

In some examples, cooperation connection circuitry 1425 adds or drops a cooperation connection with at least one of the candidate UEs. In some examples, UE capability circuitry 1430 transmits, to a network entity, an updated indication of UE capability based on the added or dropped cooperation connection.

In some aspects, communications device 1400 may be an example of (e.g., may perform operations of) a candidate UE described herein. According to some aspects, cooperating UE availability circuitry 1415 transmits, to a target UE, availability information indicating availability of the candidate UE for cooperating with the target UE for communicating with a network entity. According to some aspects, assistance information circuitry 1420 transmits, to the target UE, assistance information. According to some aspects, cooperation connection circuitry 1425 establishes a cooperation connection with the target UE based on the assistance information.

In some aspects, the assistance information includes at least one of: a supported sidelink type; a supported sidelink latency; a supported access (Uu) link; or UL maximum transmit power. In some aspects, the assistance information includes at least one of: location information of the candidate UE or an indication of a status of an access link of the candidate UE. In some aspects, the indication of the status of the access link includes at least one of: a MPE event report; a PHR; or a CSI report. In some aspects, the assistance information indicates at least one of: time windows when the candidate UE is available to cooperate with the target UE, where durations are specified for each of the time windows; or DRX cycles configured for the candidate UE. In some aspects, at least one of the availability information or the assistance information is transmitted via broadcast signaling to the target UE. In some aspects, the broadcast signaling is broadcast periodically.

In some examples, assistance information circuitry 1420 receives, from the target UE, a request for the assistance information. In some examples, assistance information circuitry 1420 transmits the assistance information in response to the request. In some aspects, the request is received in response to a trigger event. In some aspects, the trigger event involves at least one of: an MPE for a link between the network entity and the target UE or a candidate UE is above a first threshold; or measured CSI for the link between the network entity and the target UE or a candidate UE is below a second threshold.

In some aspects, at least one of the availability information or the assistance information is transmitted via dedicated signaling to the target UE. In some aspects, the dedicated signaling includes at least one of: a MAC-CE or a PSSCH. In some aspects, the dedicated signaling is transmitted based on a trigger event.

In some examples, cooperation connection circuitry 1425 adds or drops a cooperation connection with at least one of the candidate UEs. In some examples, UE capability circuitry 1430 transmits, to a network entity, an updated indication of UE capability based on the added or dropped cooperation connection.

Notably, FIG. 14 is just one example, and many other examples and configurations of communication device are possible.

### Example Clauses

Implementation examples are described in the following numbered clauses:
Clause 1: A method for wireless communication by a target user equipment, the method comprising: receiving availability information indicating availability of one or more candidate UEs for cooperating with the target UE for communicating with a network entity; receiving assistance information from at least one of the candidate UEs; establishing a cooperation connection with the at least one of the candidate UEs based on the assistance information; and transmitting, to the network entity, an indication of UE capability based on the cooperation connection.
Clause 2: The method of Clause 1, wherein the assistance information comprises at least one of: a supported sidelink type; a supported sidelink latency; a supported access (Uu) link; or UL maximum transmit power.
Clause 3: The method of any one of Clauses 1 and 2, wherein the assistance information comprises at least one of: location information of the at least one candidate UE; or an indication of a status of an access link of the candidate UE.
Clause 4: The method of Clause 3, wherein the indication of the status of the access link comprises at least one of: a MPE event report; a PHR; or a CSI report.
Clause 5 The method of any one of Clauses 1-4, wherein the assistance information indicates at least one of: time windows when the candidate UE is available to cooperate with the target UE, wherein durations are specified for each of the time windows; or DRX cycles configured for the candidate UE.
Clause 6: The method of any one of Clauses 1-5, wherein at least one of the availability information or the assistance information is received via broadcast signaling from the one or more candidate UEs.
Clause 7: The method of Clause 6, wherein the broadcast signaling is broadcast periodically.
Clause 8: The method of any one of Clauses 1-7, further comprising: transmitting a request to the at least one of the candidate UE for the assistance information; and receiving the assistance information in response to the request.
Clause 9: The method of Clause 8, wherein the request is transmitted in response to detecting a trigger event.
Clause 10: The method of Clause 9, wherein the trigger event involves at least one of: an MPE for a link between the network entity and the target UE or a cooperative UE is above a first threshold; or measured CSI for the link between the network entity and the target UE or a cooperative UE is below a second threshold.
Clause 11: The method of any one of Clauses 1-10, wherein at least one of the availability information or the assistance information is received via dedicated signaling from the one or more candidate UEs.
Clause 12: The method of Clause 11, wherein the dedicated signaling comprises at least one of: a MAC-CE or a PSSCH.
Clause 13: The method of Clause 11, wherein the dedicated signaling is transmitted based on a trigger event.
Clause 14: The method of any one of Clauses 1-13, further comprising: adding or dropping a cooperation connection with at least one of the candidate UEs; and transmitting, to a network entity, an updated indication of UE capability based on the added or dropped cooperation connection.
Clause 15: A method for wireless communication by a candidate user equipment, the method comprising transmitting, to a target UE, availability information indicating availability of the candidate UE for cooperating with the target UE for communicating with a network entity; transmitting, to the target UE, assistance information; and establishing a cooperation connection with the target UE based on the assistance information.
Clause 16: The method of Clause 15, wherein the assistance information comprises at least one of: a supported sidelink type; a supported sidelink latency; a supported access (Uu) link; or UL maximum transmit power.
Clause 17: The method of any one of Clauses 15 and 16, wherein the assistance information comprises at least one of: location information of the candidate UE or an indication of a status of an access link of the candidate UE.
Clause 18: The method of Clause 17, wherein the indication of the status of the access link comprises at least one of: a MPE event report; a PHR; or a CSI report.
Clause 19: The method of any one of Clauses 15-18, wherein the assistance information indicates at least one of: time windows when the candidate UE is available to cooperate with the target UE, wherein durations are specified for each of the time windows; or DRX cycles configured for the candidate UE.
Clause 20: The method of any one of Clauses 15-19, wherein at least one of the availability information or the assistance information is transmitted via broadcast signaling to the target UE.
Clause 21: The method of Clause 20, wherein the broadcast signaling is broadcast periodically.
Clause 22: The method of any one of Clauses 15-21, further comprising: receiving, from the target UE, a request for the assistance information; and transmitting the assistance information in response to the request.
Clause 23: The method of Clause 22, wherein the request is received in response to a trigger event.
Clause 24: The method of Clause 23, wherein the trigger event involves at least one of: an MPE for a link between the network entity and the target UE or a candidate UE is above a first threshold; or measured CSI for the link between the network entity and the target UE or a candidate UE is below a second threshold.
Clause 25: The method of any one of Clauses 15-24, wherein at least one of the availability information or the assistance information is transmitted via dedicated signaling to the target UE.
Clause 26: The method of Clause 25, wherein the dedicated signaling comprises at least one of: a MAC-CE or a PSSCH.
Clause 27: The method of Clause 25, wherein the dedicated signaling is transmitted based on a trigger event.
Clause 28: The method of any one of Clauses 15-27, further comprising: adding or dropping a cooperation connection with at least one of the candidate UEs; and transmitting, to a network entity, an updated indication of UE capability based on the added or dropped cooperation connection.
Clause 29: A processing system, comprising: a memory comprising computer-executable instructions; one or more processors configured to execute the computer-executable instructions and cause the processing system to perform a method in accordance with any one of Clauses 1-28.
Clause 30: A processing system, comprising means for performing a method in accordance with any one of Clauses 1-28.
Clause 31: A non-transitory computer-readable medium comprising computer-executable instructions that, when executed by one or more processors of a processing system, cause the processing system to perform a method in accordance with any one of Clauses 1-28.
Clause 32: A computer program product embodied on a computer-readable storage medium comprising code for performing a method in accordance with any one of Clauses 1-28.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mm Wave base station.

The communication links 120 between BSs 102 and, for example, UEs 104, may be through one or more carriers. For example, BSs 102 and UEs 104 may use spectrum up to YMHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of user equipment (UE) discovery for UE cooperation in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user equipment (as in the example UE 104 of FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A target user equipment (UE) comprising:
a memory; and
one or more processors coupled to the memory, the memory and the one or more processors being configured to cause the target UE to:
receive availability information indicating availability of one or more candidate UEs for cooperating with the target UE for communicating with a network entity;
receive assistance information from at least one of the candidate UEs;
establish a cooperation connection with the at least one of the candidate UEs based on the assistance information; and
transmit, to the network entity, an indication of UE capability based on the cooperation connection.

2. The target UE of claim 1, wherein the assistance information comprises at least one of:
a supported sidelink type;
a supported sidelink latency;
a supported access (Uu) link; or
uplink (UL) maximum transmit power.

3. The target UE of claim 1, wherein the assistance information comprises at least one of:
location information of the at least one candidate UE; or
an indication of a status of an access link of the candidate UE.

4. The target UE of claim 3, wherein the indication of the status of the access link comprises at least one of:
a maximum permissible exposure (MPE) event report;
a power headroom reports (PHR); or
a channel state information (CSI) report.

5. The target UE of claim 1, wherein the assistance information indicates at least one of:
time windows when the candidate UE is available to cooperate with the target UE, wherein durations are specified for each of the time windows; or
discontinuous reception (DRX) cycles configured for the candidate UE.

6. The target UE of claim 1, wherein:
at least one of the availability information or the assistance information is received via broadcast signaling from the one or more candidate UEs.

7. The target UE of claim 6, wherein the broadcast signaling is broadcast periodically.

8. The target UE of claim 1, wherein the memory and the one or more processors are further configured to cause the target UE to:
transmit a request to the at least one of the candidate UE for the assistance information; and
receive the assistance information in response to the request.

9. The target UE of claim 8, wherein the request is transmitted in response to detecting a trigger event.

10. The target UE of claim 9, wherein the trigger event involves at least one of:
an MPE for a link between the network entity and the target UE or a cooperative UE is above a first threshold; or
measured CSI for the link between the network entity and the target UE or a cooperative UE is below a second threshold.

11. The target UE of claim 1, wherein:
at least one of the availability information or the assistance information is received via dedicated signaling from the one or more candidate UEs.

12. The target UE of claim 11, wherein the dedicated signaling comprises at least one of:
a medium access control (MAC) control element (CE) (MAC-CE); or
a physical sidelink shared channel (PSSCH).

13. The target UE of claim 11, wherein the dedicated signaling is transmitted based on a trigger event.

14. The target UE of claim 1, wherein the memory and the one or more processors are further configured to cause the target UE to:
add or drop a cooperation connection with at least one of the candidate UEs; and
transmit, to a network entity, an updated indication of UE capability based on the added or dropped cooperation connection.

15. A candidate user equipment (UE) comprising:
a memory; and
one or more processors coupled to the memory, the memory and the one or more processors being configured to cause the candidate UE to:
transmit, to a target UE, availability information indicating availability of the candidate UE for cooperating with the target UE for communicating with a network entity;
transmit, to the target UE, assistance information; and
establish a cooperation connection with the target UE based on the assistance information.

16. The candidate UE of claim 15, wherein the assistance information comprises at least one of:
a supported sidelink type;
a supported sidelink latency;
a supported access (Uu) link; or
uplink (UL) maximum transmit power.

17. The candidate UE of claim 15, wherein the assistance information comprises at least one of:
location information of the candidate UE; or
an indication of a status of an access link of the candidate UE.

18. The candidate UE of claim 17, wherein the indication of the status of the access link comprises at least one of:
a maximum permissible exposure (MPE) event report;
a power headroom reports (PHR); or
a channel state information (CSI) report.

19. The candidate UE of claim 15, wherein the assistance information indicates at least one of:
time windows when the candidate UE is available to cooperate with the target UE, wherein durations are specified for each of the time windows; or
discontinuous reception (DRX) cycles configured for the candidate UE.

20. The candidate UE of claim 15, wherein
at least one of the availability information or the assistance information is transmitted via broadcast signaling to the target UE.

21. The candidate UE of claim 20, wherein the broadcast signaling is broadcast periodically.

22. The candidate UE of claim 15, wherein the memory and the one or more processors are further configured to cause the candidate UE to:
receive, from the target UE, a request for the assistance information; and
transmit the assistance information in response to the request.

23. The candidate UE of claim 22, wherein the request is received in response to a trigger event.

24. The candidate UE of claim 23, wherein the trigger event involves at least one of:
an MPE for a link between the network entity and the target UE or a candidate UE is above a first threshold; or
measured CSI for the link between the network entity and the target UE or a candidate UE is below a second threshold.

25. The candidate UE of claim 15, wherein:
at least one of the availability information or the assistance information is transmitted via dedicated signaling to the target UE.

26. The candidate UE of claim 25, wherein the dedicated signaling comprises at least one of:
a medium access control (MAC) control element (CE) (MAC-CE); or
a physical sidelink shared channel (PSSCH).

27. The candidate UE of claim 25, wherein the dedicated signaling is transmitted based on a trigger event.

28. The candidate UE of claim 15, wherein the memory and the one or more processors are further configured to cause the candidate UE to:
add or drop a cooperation connection with at least one of the candidate UEs; and
transmit, to a network entity, an updated indication of UE capability based on the added or dropped cooperation connection.

29. A method for wireless communication by a target user equipment (UE) comprising:
receiving availability information indicating availability of one or more candidate UEs for cooperating with the target UE for communicating with a network entity;
receiving assistance information from at least one of the candidate UEs;
establishing a cooperation connection with the at least one of the candidate UEs based on the assistance information; and
transmitting, to the network entity, an indication of UE capability based on the cooperation connection.

30. A method for wireless communication by a candidate user equipment (UE) comprising:
transmitting, to a target UE, availability information indicating availability of the candidate UE for cooperating with the target UE for communicating with a network entity;
transmitting, to the target UE, assistance information; and
establishing a cooperation connection with the target UE based on the assistance information.
